(19) United States
(12) Patent Application Publication
(10) Pub. No.: US 2020/0269543 A1
(43) Pub. Date: Aug. 27, 2020

(54) THERMAL INSULATION STRUCTURE

(71) Applicants: Inventec (Pudong) Technology Corporation, Shanghai (CN); INVENTEC CORPORATION, Taipei (TW)

(72) Inventors: Chih-Kai YANG, Taipei (TW); Yi-Lun CHENG, Taipei (TW); Meng-Lung CHIANG, Taipei (TW)

(21) Appl. No.: 16/424,583

(22) Filed: May 29, 2019

(30) Foreign Application Priority Data
Feb. 25, 2019 (CN) 201910137616.6

(51) Int. Cl. B32B 5/28; B32B 5/18; B32B 5/24; B32B 5/30; F16L 59/02

(52) U.S. Cl. CPC B32B 5/28; B32B 5/18; B32B 5/245; B32B 2307/304; F16L 59/029; B32B 2266/126; B32B 5/30

(57) ABSTRACT

This disclosure relates to a thermal insulation structure including a base plate and a thermal insulation component. The thermal insulation component is disposed on the base plate and is made of aerogel. The thermal conductivity of the base plate is higher than the thermal conductivity of the thermal insulation component.

### CROSS-REFERENCE TO RELATED APPLICATIONS

This non-provisional application claims priority under 35 U.S.C. § 119(a) on Patent Application No(s). 201910137616.6 filed in China, P.R.C. on Feb. 25, 2019, the entire contents of which are hereby incorporated by reference.

### TECHNICAL FIELD

The present disclosure relates to a thermal insulation structure, more particularly to a thermal insulation structure including aerogel.

### BACKGROUND

As the technology develops, the performance of electronic devices such as notebook computers or mobile phones increases, and heat generated by these electronic devices is more than ever. Therefore, in most cases, the electronic devices have an inbuilt heat dissipation device disposed on the heat source therein for heat dissipation.

### SUMMARY

According to one aspect of the present disclosure, a thermal insulation structure including a base plate and a thermal insulation component. The thermal insulation component is disposed on the base plate. The thermal insulation component is made of aerogel. The thermal conductivity of the base plate is higher than the thermal conductivity of the thermal insulation component.

### BRIEF DESCRIPTION OF THE DRAWINGS

The present disclosure will become more fully understood from the detailed description given hereinbelow and the accompanying drawings which are given by way of illustration only and thus are not intending to limit the present disclosure and wherein:

FIG. 1 is a perspective view of a thermal insulation structure according to one embodiment of the present disclosure;

FIG. 2 is a cross-sectional view of the thermal insulation structure in FIG. 1;

FIG. 3 is an exploded view of a thermal insulation structure according to another embodiment of the present disclosure;

FIG. 4 is a cross-sectional view of the thermal insulation structure in FIG. 3;

FIG. 5 is an exploded view of a thermal insulation structure according to yet another embodiment of the present disclosure;

FIG. 6 is a cross-sectional view of the thermal insulation structure in FIG. 5;

FIG. 7 is an exploded view of a thermal insulation structure according to yet still another embodiment of the present disclosure;

FIG. 8 is a cross-sectional view of the thermal insulation structure in FIG. 7;

FIG. 9 is an exploded view of a thermal insulation structure according to yet still further another embodiment of the present disclosure; and

FIG. 10 is a cross-sectional view of the thermal insulation structure in FIG. 9.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

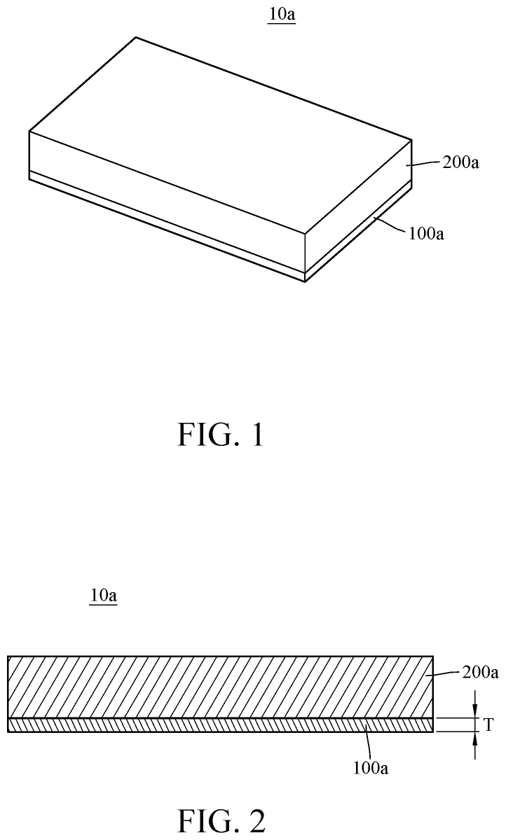

Please refer to FIG. 1 and FIG. 2, which FIG. 1 is a perspective view of a thermal insulation structure 10a according to one embodiment of the present disclosure, and FIG. 2 is a cross-sectional view of the thermal insulation structure 10a in FIG. 1.

In this embodiment, the thermal insulation structure 10a is applicable to, for example, an electronic device (not shown), such as notebook computer. The thermal insulation structure 10a as a thermal insulator may be disposed between the shell of the electronic device and a heat source in the electronic device. The thermal insulation structure 10a includes a base plate 100a and a thermal insulation component 200a. The thermal insulation component 200a is disposed on the base plate 100a by, for example, adhering. The thermal conductivity of the base plate 100a is higher than the thermal conductivity of the thermal insulation component 200a. The material of the base plate 100a includes, for example, metal, that has a high thermal conductivity, such as copper or aluminum. The thermal insulation component 200a is made of aerogel having a low thermal conductivity. In other words, the thermal insulation component 200a has a lower thermal conductivity than the base plate 100a.

Specifically, in this and some embodiment of the present disclosure, the base plate 100a has a thickness T of, for example, approximately 0.5 millimeters (mm), but the present disclosure is not limited thereto. In some embodiments, the thickness of the base plate may approximately be 0.4 mm, 0.3 mm, 0.2 mm, or 0.1 mm. In this and some embodiments, the material of the base plate 100a includes, for example, metal that has a thermal conductivity higher than 200 W/mK, and the thermal insulation component 200a is made of aerogel that has a thermal conductivity approximately 0.02 W/mK. Therefore, the thermal conductivity of the base plate 100a is much higher than the thermal conductivity of the thermal insulation component 200a; in such a case, with respect to the thermal insulation component 200a, the base plate 100a can be considered to be a thermal conductor, and with respect to the base plate 100a, the thermal insulation component 200a can be considered to be a thermal insulator.

The thermal insulation structure 10a can be thermally in contact with the heat source in the electronic device via the base plate 100a to absorb the heat generated by the heat source, and the heat will evenly spread on the base plate 100a due to the high thermal conductivity of the base plate 100a. This helps to prevent overheat of the heat source so as to prevent the performance degradation and malfunction of the electronic device.

Further, the aerogel made thermal insulation component 200a is in solid form thermal insulator that has low thermal conductivity and is disposed on a side of the base plate 100a opposite the electronic device, such that the thermal insulation component 200a is able to effectively suppress the heat conduction between the base plate 100a and the environment.

In addition, the thermal insulation component 200a may have a plurality of internal holes that may be separated from one another, such that there is no convection between the internal holes and the internal holes may offer resistance to heat convection from either side of the thermal insulation component 200a. Further, there is some air in the internal holes, and air also has low thermal conductivity with respect to the base plate 100a. Therefore, the air in the internal holes in the thermal insulation component 200a also help to suppress the heat conduction between the base plate 100a and the environment.

Also, the thermal insulation component 200a can insulate heat radiation from the side of the base plate 100a opposite the electronic device. And carbon, that can further insulate heat radiation, may be added into the thermal insulation component 200a to further suppress the heat radiation from either side of the thermal insulation component 200a.

In summary, the thermal insulation component 200a is able to effectively suppress the heat conduction, heat convection and heat radiation from the side of the base plate 100a opposite the electronic device. As a result, the thermal insulation component 200a may be disposed inside the shell of the electronic device and can suppress heat transfer between the base plate 100a and the shell of the electronic device, and the temperature of the shell may not be raised too much by the heat source. Therefore, the user will not be feeling uncomfortable when touching the shell of the electronic device.

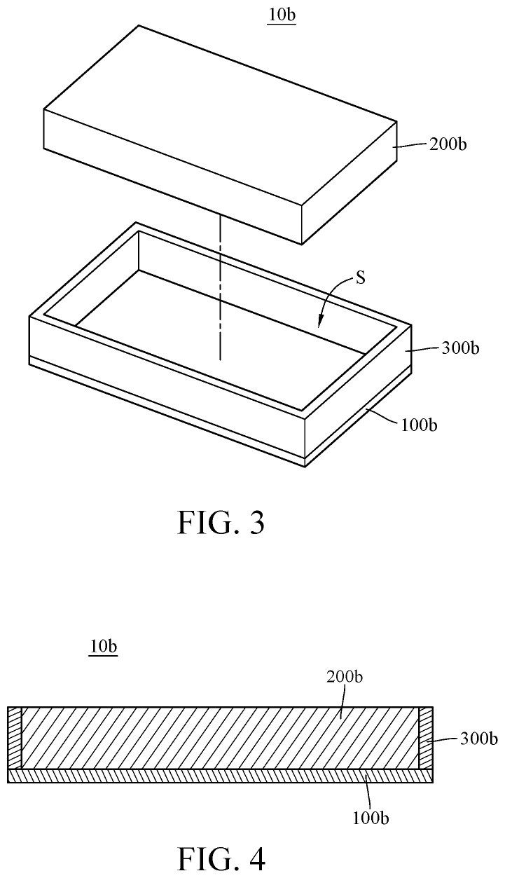

Please refer to FIG. 3 and FIG. 4, which FIG. 3 is an exploded view of a thermal insulation structure 10b according to another embodiment of the present disclosure, and FIG. 4 is a cross-sectional view of the thermal insulation structure 10b in FIG. 3. It is noted that only the differences between these two embodiments are described hereinafter. In this and some embodiments of the present disclosure, the thermal insulation structure 10b may further include a sidewall 300b disposed on a base plate 100b. The sidewall 300b includes four side plates that go along the base plate 100b. The sidewall 300b and the base plate 100b together form a space S therebetween, and a thermal insulation component 200b is located in the space S. The present disclosure is not limited by the configuration of the sidewall 300b. In some embodiments, the sidewall may only include two side plates. In this and some embodiment, the space S, formed by the base plate 100b and the sidewall 300b, can be used for accommodating the aerogel either in powder form or gel form. During the manufacturing process, the thermal insulation structure 10b was heated so as to solidify and turn the aerogel into the thermal insulation component 200b. By doing so, the thermal insulation component 200b can be fixed in place in the space S without additional adhesive.

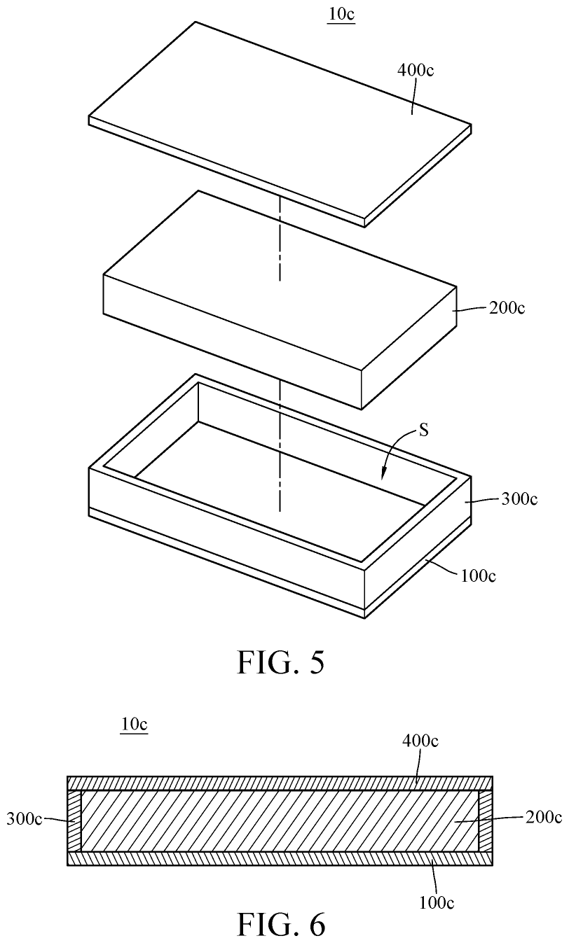

Please refer to FIG. 5 and FIG. 6, which FIG. 5 is an exploded view of a thermal insulation structure 10c according to yet another embodiment of the present disclosure, and FIG. 6 is a cross-sectional view of the thermal insulation structure 10c in FIG. 5. It is noted that only the differences from the preceding embodiments are described hereinafter. In this and some embodiments of the present disclosure, the thermal insulation structure 10c may further include a cover plate 400c disposed on a side of a sidewall 300c which is opposite a base plate 100c. The cover plate 400c, the sidewall 300c, and the base plate 100c together form a space S therebetween for accommodating a thermal insulation component 200c. The cover plate 400c covers and holds the thermal insulation component 200c in place in the space S so as to prevent the thermal insulation component 200c coming off from the base plate 100c. Further, the space S can be sealed by the cover plate 400c, the sidewall 300c, and the base plate 100c. Therefore, the configuration of the cover plate 400c, the sidewall 300c, and the base plate 100c allows the space S to be vacuumed. The thermal conductivity of air is still slightly higher than that of aerogel. Hence, as the space S has been vacuumed, the overall heat transfer capability of the thermal insulation component 200c may not be unwantedly increased.

Furthermore, in this and some embodiments of the present disclosure, the thermal conductivity of the base plate 100c may be different from that of the sidewall 300c or the cover plate 400c. Specifically, the base plate 100c may have a higher thermal conductivity than the sidewall 300c and the cover plate 400c. In such a configuration, when the base plate 100c is in thermal contact with a heat source in the electronic device, heat conduction from the base plate 100c to the sidewall 300c and cover plate 400c may be suppressed, but the present disclosure is not limited thereto. In some embodiments, the base plate and the sidewall may have the same thermal conductivity, and the cover plate may have a lower thermal conductivity than the base plate and sidewall. Alternatively, in some other embodiments, the cover plate may have a higher thermal conductivity than the sidewall and the base plate; in this case, the cover plate may be in thermal contact with the heat source, and the base plate may be disposed opposite the electronic device, such that heat generated by the heat source can be absorbed by the cover plate.

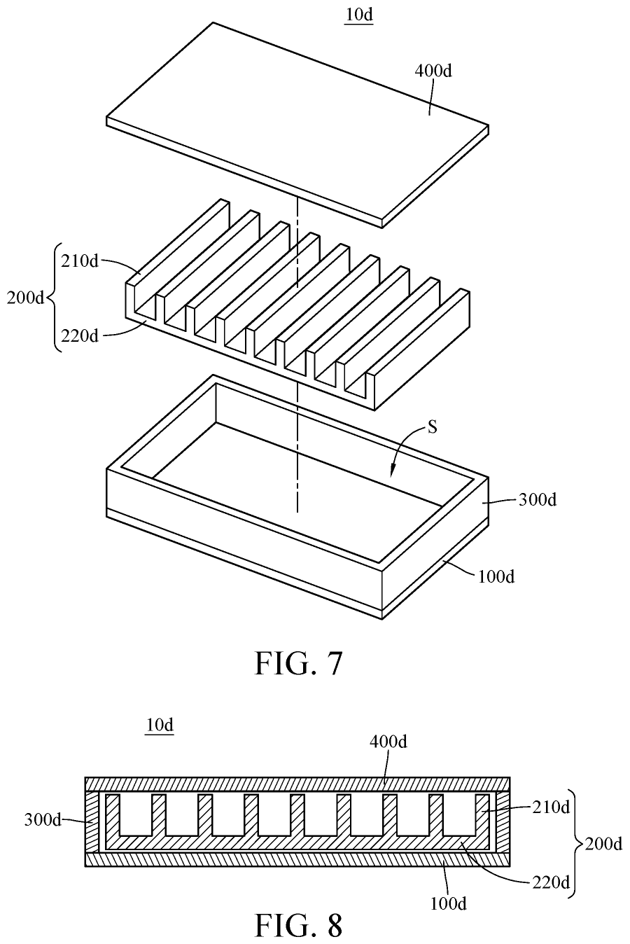

Please refer to FIG. 7 and FIG. 8, which FIG. 7 is an exploded view of a thermal insulation structure 10d according to yet still another embodiment of the present disclosure, and FIG. 8 is a cross-sectional view of the thermal insulation structure 10d in FIG. 7. It is noted that only the differences from the preceding embodiments are described hereinafter. In this and some embodiments of the present disclosure, a thermal insulation component 200d of the thermal insulation structure 10d may further include a plurality of fins 210d and a connection portion 220d. The fins 210d are spaced apart from one another and disposed on the connection portion 220d; that is, the fins 210d are connected to one another via the connection portion 220d.

Specifically, the fins 210d are disposed on a side of the connection portion 220d. The connection portion 220d is, for example, in contact with a side of the base plate 100d facing a cover plate 400d. The fins 210d each protrude toward the cover plate 400d from the connection portion 220d by the same distance and may in contact with a side of the cover plate 400d facing the base plate 100d so as to provide support to both the base plate 100d and the cover plate 400d. As shown in the figure, the space S is not fully occupied by the thermal insulation component 200d, such that the thermal insulation structure 10d may have a less amount of the thermal insulation component 200d and thereby reducing the cost. Note that the thermal insulation component 200d may be placed upside down; that is, the thermal insulation component 200d may be in contact with the base plate 100d and the cover plate 400d respectively by the fins 210d and the connection portion 220d. In addition, in some other embodiments, the fins of the thermal insulation component may protrude from the connection portion by different distances while providing support to the base plate and/or the cover plate. Further, similarly, the configuration of the base plate 100d, a sidewall 300d and the cover plate 400 also allows the space S to be vacuumed, and the overall heat transfer capability of the thermal insulation component 200d may not be unwantedly increased.

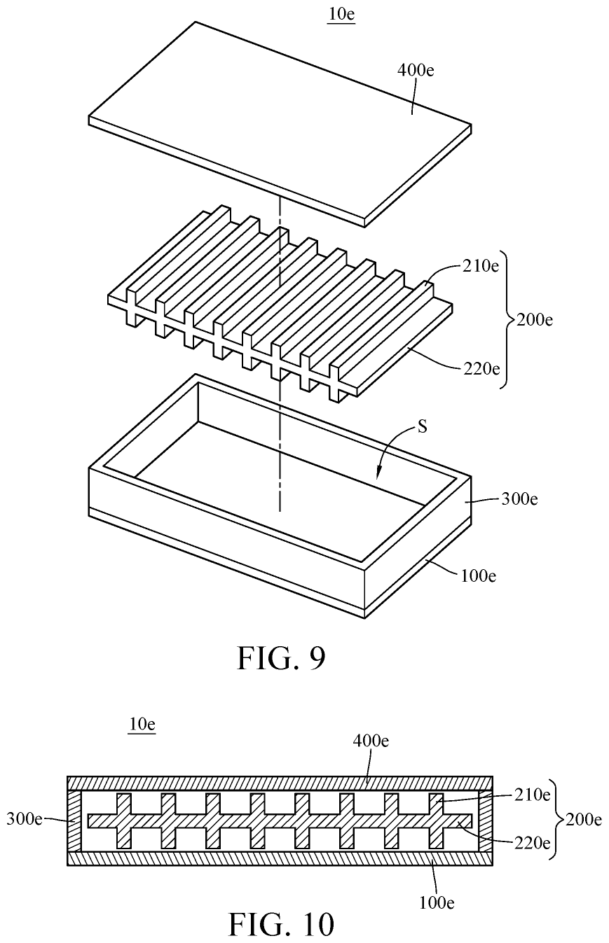

Please refer to FIG. 9 and FIG. 10, which FIG. 9 is an exploded view of a thermal insulation structure 10e according to yet still further another embodiment of the present disclosure, and FIG. 10 is a cross-sectional view of the thermal insulation structure 10e in FIG. 9. It is noted that only the differences from the preceding embodiments are described hereinafter. In this and some embodiments, a plurality of fins 210e of a thermal insulation component 200e are disposed on two opposite sides of a connection portion 220e. Part of the fins 210e protrude toward a base plate 100e by the same distance, and the other part of the fins 210e protrude toward a cover plate 400e by the same distance. And the fins 210e may in direct contact with the base plate 100e and/or the cover plate 400e. Accordingly, the protrusion of the fins 210e from the connection portion 220e may be less than that of the aforementioned embodiments, and the fins 210e also can provide support to the base plate 100e and the cover plate 400e. Similarly, the configuration of the base plate 100e, a sidewall 300e and the cover plate 400e also allows the space S to be evacuated, and the overall heat transfer capability of the thermal insulation component 200e may not be unwantedly increased.

According to the thermal insulation structure discussed above, the base plate can absorb the heat generated by the heat source of the electronic device; meanwhile, the thermal insulation component, which is made of aerogel and in solid form thermal insulator, has low thermal conductivity, such that the thermal insulation component is able to effectively suppress the heat conduction, heat convection, or heat radiation from the electronic device. The temperature of the shell may not be raised too much by the heat source. Therefore, the user will not be feeling uncomfortable when touching the shell of the electronic device.

In some embodiments, the thermal insulation structure may further include a sidewall. The space, formed by the base plate and the sidewall, can be used for accommodating the aerogel either in powder form or gel form. During the manufacturing process, the thermal insulation structure was heated so as to solidify and turn the aerogel into the thermal insulation component. By doing so, the thermal insulation component can be fixed in place in the space without additional adhesive.

In some embodiments, the thermal insulation structure may further include a cover plate. The cover plate covers and holds the thermal insulation component in place in the space so as to prevent the thermal insulation component coming off from the base plate. Further, the space can be vacuumed, the overall heat transfer capability of the thermal insulation component may not be unwantedly increased.

In some embodiments, the base plate may have a higher thermal conductivity than the sidewall and the cover plate. In such a configuration, when the base plate is in thermal contact with the heat source in the electronic device, heat conduction from the base plate to the sidewall and cover plate may be suppressed.

In some embodiments, the thermal insulation component may further include a plurality of fins and a connection portion. The connection portion is in contact with a side of the base plate facing a cover plate. The fins each protrude toward the cover plate from the connection portion by the same distance and may in contact with a side of the cover plate facing the base plate so as to provide support to both the base plate and the cover plate. The space is not fully occupied by the thermal insulation component, such that the thermal insulation structure may have a less amount of the thermal insulation component and thereby reducing the cost.

In some embodiments, the fins of the thermal insulation component may be disposed on two opposite sides of the connection portion. Part of the fins protrude toward a base plate by the same distance, and the other part of the fins protrude toward a cover plate by the same distance. And the fins may in direct contact with the base plate and/or the cover plate. Accordingly, the protrusion of the fins from the connection portion may be less, and the fins also can provide support to the base plate and the cover plate.

The embodiments are chosen and described in order to best explain the principles of the present disclosure and its practical applications, to thereby enable others skilled in the art best utilize the present disclosure and various embodiments with various modifications as are suited to the particular use being contemplated. It is intended that the scope of the present disclosure is defined by the following claims and their equivalents.

What is claimed is:

1. A thermal insulation structure, comprising:
a base plate; and
a thermal insulation component, disposed on the base plate, wherein the thermal insulation component is made of aerogel;
wherein a thermal conductivity of the base plate is higher than a thermal conductivity of the thermal insulation component.

2. The thermal insulation structure according to claim 1, further comprising a side plate disposed on the base plate, wherein the side plate and the base plate form a space therebetween, and the thermal insulation component is located in the space.

3. The thermal insulation structure according to claim 1, further comprising a cover plate and a side plate, the side plate disposed on the base plate, the cover plate disposed on a side of the side plate opposite the base plate, wherein the cover plate, the side plate and the base plate together form a space therebetween.

4. The thermal insulation structure according to claim 3, wherein the thermal conductivity of the base plate is different from a thermal conductivity of the cover plate or a thermal conductivity of the side plate.

5. The thermal insulation structure according to claim 1, wherein the thermal insulation component further comprises a plurality of fins and a connection portion, the plurality of fins are disposed on the connection portion, and the plurality of fins are connected to one another via the connection portion.

6. The thermal insulation structure according to claim 5, wherein the plurality of fins are disposed on a side of the connection portion.

7. The thermal insulation structure according to claim 5, wherein the plurality of fins are disposed on two opposite sides of the connection portion.

8. The thermal insulation structure according to claim 5, wherein the plurality of fins protrude from the connection portion by a same distance.

9. The thermal insulation structure according to claim 1, wherein the base plate is made of metal.

10. The thermal insulation structure according to claim 1, wherein the base plate has a thickness substantially less than 0.5 millimeters.
